(19) United States
(12) Patent Application Publication
(10) Pub. No.: US 2017/0289197 A1
(43) Pub. Date: Oct. 5, 2017

(54) TRANSPORT LAYER SECURITY TOKEN BINDING AND TRUSTED SIGNING

(71) Applicant: QUALCOMM Incorporated, San Diego, CA (US)

(72) Inventors: Giridhar MANDYAM, San Diego, CA (US); Jon AZEN, San Diego, CA (US); Laurence LUNDBLADE, San Diego, CA (US)

(21) Appl. No.: 15/342,859

(22) Filed: Nov. 3, 2016

Related U.S. Application Data
(60) Provisional application No. 62/316,164, filed on Mar. 31, 2016.

(51) Int. Cl. H04L 29/06; H04L 9/32; H04L 9/08; H04L 29/08

(52) U.S. Cl. CPC H04L 63/20; H04L 67/141; H04L 63/166; H04L 63/10; H04L 63/06; H04L 63/0428; H04L 9/32; H04L 9/0825; H04L 67/42; H04L 63/08

(57) ABSTRACT

Techniques for managing data communications are provided. A method according to these techniques includes establishing a secure communication session between a client device and a server over a network, the secure communication session comprising one or more communication subsessions in which data is exchanged between the client device and the server. Establishing the secure communication session include providing an access token to the server, the access token comprising information for securely binding the one or more communication subsessions to the secure communication session, and providing attestation information to the server, the attestation information attesting to security of management of the access token by the client device.

### CROSS REFERENCE TO RELATED APPLICATION

This application claims priority to U.S. Provisional Patent Application Ser. No. 62/316,164, entitled “Transport layer security Token Binding and Trusted Signing,” filed on Mar. 31, 2016, all of which are assigned to the assignee hereof and incorporated by reference.

### BACKGROUND

Identity federation systems are commonly used means for linking identity information for a user across multiple identity management systems. The identity information can be used to authenticate the user and to authorize the user to access various applications, content, and/or services provided by one or more providers. One use of identity federation systems is to provide “single sign-on” services in which a user can use a single set of authentication credentials to gain access to multiple systems without having to sign into each of the systems separately.

### SUMMARY

An example method for managing data communications according to the disclosure includes establishing a secure communication session between a client device and a server over a network. The secure communication session includes one or more communication subsessions in which data is exchanged between the client device and the server. Establishing the secure communication session includes providing an access token to the server, the access token comprising information for securely binding the one or more communication subsessions to the secure communication session, and providing attestation information to the server, the attestation information attesting to security of management of the access token by the client device.

Implementations of such a method can include one or more of the following features. Providing the attestation information to the server includes signing at least a portion of the attestation information with an attestation private key associated with a secure component of the client device and providing the attestation information that has been signed to the server. Estimating a lifespan of a communication subsession associated with the secure communication session; and selecting a technique for signing the access token from a plurality of techniques of which the client device is configured to perform based on the lifespan estimated of the communication subsession and an estimate of a time to perform the technique selected for signing at least the portion of the attestation information. Selecting a technique for signing data to be communicated to the server from a plurality of techniques of which the client device is configured to perform based on policy information received from the server. The attestation information includes at least one of information identifying which encryption algorithms that the client device is configured to support, information indicating whether the access token is stored in a secured memory location, or information indicating whether a private key associated with the client device is stored in the secured memory location. Providing the attestation information to the server includes providing an indicator that the client device will suppress sending the attestation information for future secure communication sessions between the client device and the server.

An example apparatus according to the disclosure includes means for establishing a secure communication session between the apparatus and a server over a network. The secure communication session includes one or more communication subsessions in which data is exchanged between the apparatus and the server. The means for establishing the secure communication session include means for providing an access token to the server, the access token comprising information for securely binding the one or more communication subsessions to the secure communication session, and means for providing attestation information to the server, the attestation information attesting to security of management of the access token by the apparatus.

Implementations of such an apparatus can include one or more of the following features. The means for providing the attestation information to the server includes means for signing at least a portion of the attestation information with an attestation private key associated with a secure component of the apparatus and providing the attestation information that has been signed to the server. Means for estimating a lifespan of a communication subsession associated with the secure communication session, and means for selecting a technique for signing the access token from a plurality of techniques of which the apparatus is configured to perform based on the lifespan estimated of the communication subsession and an estimate of a time to perform the technique selected for signing at least the portion of the attestation information. Means for selecting a technique for signing data to be communicated to the server from a plurality of techniques of which the apparatus is configured to perform based on policy information received from the server. The attestation information comprises at least one of information identifying which encryption algorithms that the apparatus is configured to support, information indicating whether the access token is stored in a secured memory location, or information indicating whether a private key associated with the apparatus is stored in the secured memory location. The means for providing the attestation information to the server further comprises means for providing an indicator that the apparatus will suppress sending the attestation information for future secure communication sessions between the apparatus and the server.

A non-transitory, computer-readable medium according to the disclosure having stored thereon computer-readable instructions for managing data communications includes instructions configured to cause at least one processor to establish a secure communication session between a client device and a server over a network, the secure communication session comprising one or more communication subsessions in which data is exchanged between the client device and the server. The instructions configured to cause the at least one processor to establish the secure communication session comprises instructions to cause the at least one processor to provide an access token to the server, the access token comprising information for securely binding the one or more communication subsessions to the secure communication session, and provide attestation information to the server, the attestation information attesting to security of management of the access token by the client device.

Implementations of such a non-transitory, computer-readable medium can include one or more of the following features. The instructions configured to cause the at least one processor to provide the attestation information to the server include instructions configured to cause the at least one processor to sign at least a portion of the attestation information with an attestation private key associated with a secure component of the client device and providing the attestation information that has been signed to the server. Instructions configured to cause the at least one processor to estimate a lifespan of a communication subsession associated with the secure communication session, and select a technique for signing the access token from a plurality of techniques of which the client device is configured to perform based on the lifespan estimated of the communication subsession and an estimate of a time to perform the technique selected for signing at least the portion of the attestation information. Instructions configured to cause the at least one processor to select a technique for signing data to be communicated to the server from a plurality of techniques of which the client device is configured to perform based on policy information received from the server. The attestation information includes at least one of information identifying which encryption algorithms that the client device is configured to support, information indicating whether the access token is stored in a secured memory location, or information indicating whether a private key associated with the client device is stored in the secured memory location. Instructions configured to cause the at least one processor to provide an indicator that the client device will suppress sending the attestation information for future secure communication sessions between the client device and the server.

An example client device according to the disclosure includes a processor. The processor is configured to establish a secure communication session between the client device and a server over a network, the secure communication session comprising one or more communication subsessions in which data is exchanged between the client device and the server. The processor is further configured provide an access token to the server, the access token comprising information for securely binding the one or more communication subsessions to the secure communication session, and provide attestation information to the server, the attestation information attesting to security of management of the access token by the client device.

Implementations of such a client device can include one or more of the following features. The processor is configured to sign at least a portion of the attestation information with an attestation private key associated with a secure component of the client device and providing the attestation information that has been signed to the server. The processor is further configured to estimate a lifespan of a communication subsession associated with the secure communication session, and select a technique for signing the access token from a plurality of techniques of which the client device is configured to perform based on the lifespan estimated of the communication subsession and an estimate of a time to perform the technique selected for signing at least the portion of the attestation information. The processor is further configured to select a technique for signing data to be communicated to the server from a plurality of techniques of which the client device is configured to perform based on policy information received from the server. The attestation information comprises at least one of information identifying which encryption algorithms that the client device is configured to support, information indicating whether the access token is stored in a secured memory location, or information indicating whether a private key associated with the client device is stored in the secured memory location. The processor is further configured to provide to the server an indicator that the client device will suppress sending the attestation information for future secure communication sessions between the client device and the server.

### BRIEF DESCRIPTION OF THE DRAWINGS

FIG. 1 is a schematic diagram of an example operating environment that includes a mobile wireless device in communication with one or more wireless nodes, in accordance with certain example implementations.

FIG. 2 is a schematic diagram of an example wireless device (e.g., a mobile wireless device), in accordance with certain example implementations.

FIG. 3 is a schematic diagram of an example server, in accordance with certain example implementations.

FIG. 4 is a schematic diagram of an example computing system, in accordance with certain example implementations.

FIG. 5 is a flow diagram of an example process in which a client device can obtain an access token from an access server, in accordance with certain example embodiments.

FIG. 6 is a flow diagram of an example process for generating an access token, in accordance with certain example embodiments.

FIG. 7A is a flow diagram of an example process for managing data communications, in accordance with certain example embodiments.

FIG. 7B is a flow diagram of an example process for establishing a secure communication session, in accordance with certain example embodiments.

FIG. 8A is a flow diagram of an example process for establishing a secure communication session, in accordance with certain example embodiments.

FIG. 8B is a flow diagram of an example process for establishing a secure communication session, in accordance with certain example embodiments.

FIG. 9 is a signal flow diagram illustrating example interactions between a client device and a content server to conduct an secure communication session in accordance with certain example implementations.

Like reference symbols in the various drawings indicate like elements, in accordance with certain example implementations.

### DETAILED DESCRIPTION

Described herein are methods, systems, devices, computer readable media, and other implementations, for implementing token binding techniques that can be used to establish a secure communication session between a client device and a server over a network, such as the collection of networks collectively referred to as the Internet. An access token can be provided by a client device to a server to indicate to the server that the user of the client device is authorized to access an application or some content provided by the server. The access token may be obtained from an access server by the client device, and may be obtained by presenting authorization credentials, such as a username and password or other information that may be used to identify a user of the client device or the client device itself, to the access server (referred to herein as an access server). The access server may then issue an access token to the client device that the client device can present to a content server to indicate that the user is entitled to access applications, content, and/or services provided by the content server. The access token may be valid for applications, content, and/or services provided by the content server or provided by more than one content server. For example, the access token may provide access to social media content, email content, an online shopping account, and/or other types of applications, content, and/or services.

Possession of the access token alone, however, may be insufficient to ensure that the user is actually authorized to possess the access token. The access token may have been stored in a rich execution environment of the client device, and the token may have been manipulated or even stolen while stored in such an environment. A rich execution environment can be used to execute application content on the client device and the content associated with the rich execution environment may be subject to unauthorized manipulation by malicious third parties through software and/or hardware exploits. An access token stored in the rich execution environment may be stolen through such a software or hardware exploit and be used by the malicious party to obtain unauthorized access to the applications, content, and/or services accessible using the access token. To prevent theft of the access token, the access token may also be stored in a trusted execution environment or trusted component of the client device. The trusted execution environment or trusted component can provide an execution environment that is isolated from the rich execution environment and can provide for protected execution of authenticated code, data confidentiality, and data integrity. The trusted execution environment or trusted component can be used to store sensitive information, such as encryption keys and the access tokens, to reduce the likelihood that this sensitive information may be stolen or modified by a malicious third party.

According to the techniques disclosed herein, the client device can be configured to provide attestation information with the access token. The attestation information can be used to provide information that a content server can use to determine whether to provide access to the client device. The attestation information can provide information including whether the client device stores the encryption keys and access tokens in a trusted execution environment or trusted component or in the rich execution environment. The attestation information can also indicate which encryption algorithms the client device supports. The attestation information can be used by the content server to make a determination whether to provide access to a requested application, content, or service. The attestation information can also include other information that the content server can use to make such a determination. Furthermore, the content server can utilize policy information that defines the specific level of security that is required for the client device to be able to access the particular application, content, or service. Some applications, content, or services may require that the client device implement stronger security safeguards for maintaining the integrity and authenticity of the access token, encryption keys utilized by the client device, etc. For example, the server-side policy information may require that the client device store the access tokens and encryption keys in a trusted execution environment or trusted component in order to access a banking or financial application, content, or service, but may implement a server-side policy information that allows access to social media related applications, content, or services by client devices that store access tokens in a rich execution environment.

The techniques disclosed herein can be used to add increased security to the Transport Layer Security protocol and/or other such secure communication protocols. A client device can obtain an access token that can be used in conducting a secure communication session with a content server. The access token can comprise information that can be used to securely bind together one or more subsessions of the secure communications session. The information included in the access token can be a public key of a private key-public key set of encryption keys. The private key is kept secret by the client device and can be used to digitally sign a nonce value provided by the content server. The content server can verify the digital signature of the nonce value using the public key associated with the client device to establish that the client device was in possession of the private key (and thus, the authentication token). These techniques can prevent the access token from being exported by a malicious party and exploited to obtain access to applications, content, or services by an unauthorized party from another client device, because the other client device would not possess the required private key. The techniques disclosed herein can provide additional layer of security by providing attestation information to the content server in addition to the access token. The attestation information can indicate how the client device manages the storage and security of encryption keys and the access tokens, so that the content server does not have to operate on the assumption that the encryption keys and/or the access token may have been stored in an unsecure manner on the client device.

Example embodiments include, for example, methods including one or more of:
Methods, systems, devices, computer readable media, and other implementations for managing data communications. An example method according to these techniques includes:
   establishing a secure communication session between a client device and a server over a network, the secure communication session comprising one or more communication subsessions in which data is exchanged between the client device and the server, wherein establishing the secure communication session comprises
   providing an access token to the server, the access token comprising information for securely binding the one or more communication subsessions to the secure communication session;
   providing attestation information to the server, the attestation information attesting to security of management of the access token by the client device.
Methods, systems, devices, computer readable media, and other implementations for managing data communications. An example method according to these techniques includes:
   receiving a request to establish a secure communication session between a client device and a server from the client device, the secure communication session comprising one or more communication subsessions in which data is exchanged between the client device and the server, wherein establishing the secure communication session comprises
      receiving an access token and attestation information from the client device, the access token comprising information for securely binding the one or more communication subsessions to the secure communication session, and the attestation information attesting to security of management of the access token by the client device; and
   determining the secure communication with the client device can be established based on the access token and the attestation information; and
   establishing the secure communication session responsive a determination that the secure communication session can be established.
Implementations of such example systems and methods are illustrated in the accompanying figures and discussed in detail in the following example implementations.

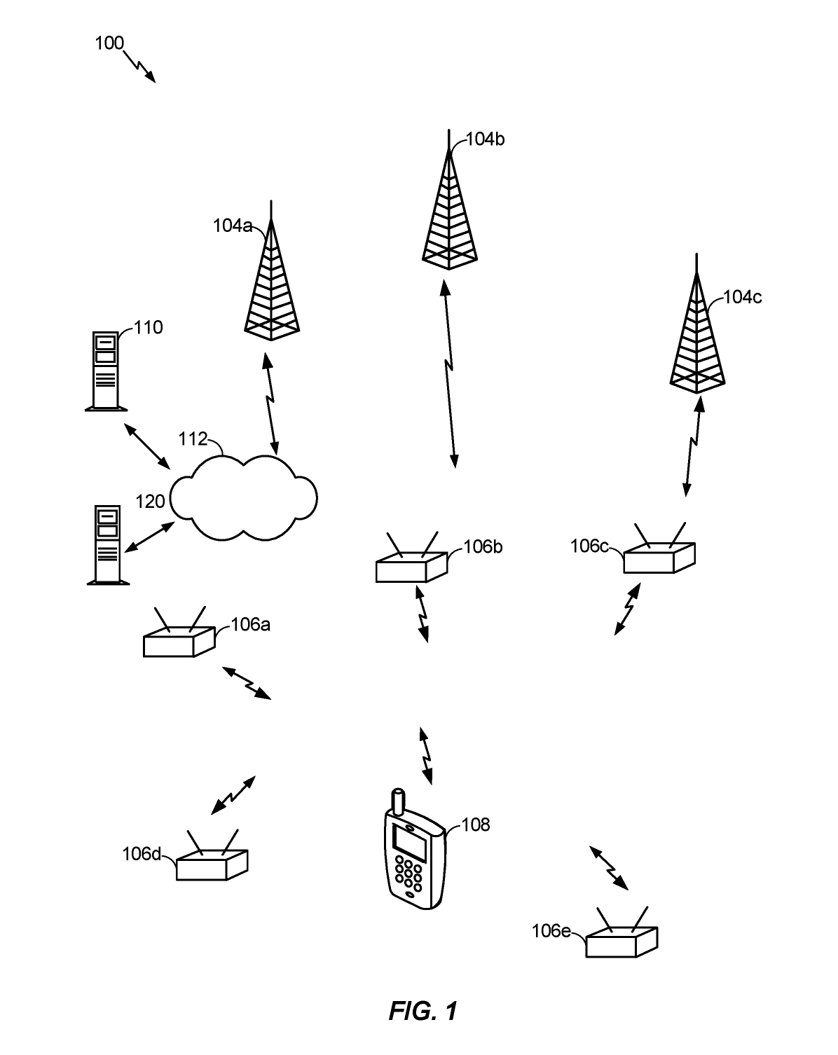

With reference to FIG. 1, shown is a schematic diagram of an example operating environment 100 that includes a client device 108 (also referred to as a mobile wireless device, a mobile station, and a wireless device) in communication with one or more wireless nodes. The client device 108 can serve as the client device in the various techniques disclosed herein. In some implementations, the client device 108 may be implemented in a computing device that is stationary or may be moveable, but is typically not moved, such as a desktop computer system, smart television, or other type of network-enabled computing device from which a user may access applications, content, or services provided by the content server 120. The client device 108 can also be configured to obtain an access token from the access server 110, and the access token can include information which can be used to bind the one or more communication subsessions to a secure communication session between the client device and the content server 120. The content server 120 can be configured to provide content related to online banking and/or investments, social media, payment systems, enterprise data systems, online retail, and/or other content which can include sensitive data for which access to view and/or modify the content or conduct transactions is desired.

The client device 108 is configured, in some embodiments, to obtain location information for one or more of the wireless nodes (e.g., WAN access points 104a-c and 106a-e depicted in FIG. 1 or another client device 108) with which the client device communicates, to receive and measure signals from the one or more wireless nodes (e.g., to determine/derive signal strength values for the received signals), to process the received and measured signals based, at least in part, on the obtained location information, to determine the range of the client device 108 to the one or more of the wireless node, and/or to perform other operations utilizing the ranging information such as determining the location of the client device 108.

The client device 108 may be configured, in some embodiments, to operate and interact with multiple types of other communication systems/devices, including local area network devices (or nodes), such as WLAN for indoor communication, femtocells, Bluetooth® wireless technology-based transceivers, and other types of indoor communication network nodes, wide area wireless network nodes, satellite communication systems, etc., and as such the client device 108 may include one or more interfaces to communicate with the various types of communications systems. As used herein, communication systems/devices/nodes with which the client device 108 may communicate are also referred to as access points (AP's) or base stations.

As noted, the operating environment 100 may contain one or more different types of wireless communication systems or nodes. Such nodes, also referred to as wireless access points (or WAPs) may include LAN and/or WAN wireless transceivers, including, for example, WiFi base stations, femtocell transceivers, Bluetooth® wireless technology transceivers, cellular base stations, WiMAX transceivers, etc. Thus, for example, and with continued reference to FIG. 1, the operating environment 100 may include the Local Area Network Wireless Access Points (LAN-WAPs) 106a-e that may be used for wireless voice and/or data communication with the client device 108. The LAN access points 106a-e may also be utilized, in some embodiments, as independent sources of position data, e.g., through fingerprinting-based procedures, through implementation of multilateration-based procedures based, for example, on timing-based techniques (e.g., RTT-based measurements), signal strength measurements (e.g., RSSI measurements), etc. The LAN access points 106a-e can be part of a Wireless Local Area Network (WLAN), which may operate in buildings and perform communications over smaller geographic regions than a WWAN. Additionally in some embodiments, the LAN access points 106a-e could also include picocells or femtocells. In some embodiments, the LAN access points 106a-e may be part of, for example, WiFi networks (802.11x), cellular piconets and/or femtocells, Bluetooth® wireless technology Networks, etc. Although five (5) LAN-WAP access points are depicted in FIG. 1, any number of such LAN-WAPs may be used, and, in some embodiments, the operating environment 100 may include no LAN-WAPs access points at all, or may include a single LAN-WAP access point.

As further illustrated, the operating environment 100 may also include a plurality of one or more types of the WAN access points 104a-c (also referred to herein as “Wide Area Network Wireless Access Points” or “WAN-WAPs”), which may be used for wireless voice and/or data communication, and may also serve as another source of independent information through which the client device 108 may determine its position/location. The WAN access points 104a-c may be part of wide area wireless network (WWAN), which may include cellular base stations, and/or other wide area wireless systems, such as, for example, WiMAX (e.g., 802.16). A WWAN may include other known network components which are not shown in FIG. 1. Typically, each of the WAN access points 104a-c within the WWAN may operate from fixed positions or may be moveable, and may provide network coverage over large metropolitan and/or regional areas. Although three (3) WAN-WAPs are depicted in FIG. 1, any number of such WAN-WAPs may be used. In some embodiments, the operating environment 100 may include no WAN-WAPs at all, or may include a single WAN-WAP.

Communication to and from the client device 108 (to exchange data, enable location determination operations with respect to the position(s) of the client device 108, etc.) may be implemented, in some embodiments, using various wireless communication networks and/or technologies such as a wide area wireless network (WWAN), a wireless local area network (WLAN), a wireless personal area network (WPAN), and so on. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may also be implemented, at least in part, using an IEEE 802.11x network, and a WPAN may be a Bluetooth® wireless technology network, an IEEE 802.15x, or some other type of network. The techniques described herein may also be used for any combination of WWAN, WLAN and/or WPAN.

The operating environment 100 may include an access server 110 and a content server 120. The access server 110 and the content server 120 can be configured to communicate, via a network 112 (e.g., a cellular wireless network, a WiFi network, a packet-based private or public network, such as the public Internet), or via wireless transceivers included with each respective server, with multiple network elements or nodes, and/or mobile devices. The functionality of the access server 110 and the content server 120 can be implemented in separate servers as shown in FIG. 1 or can alternatively be implemented in the same server or set of servers. Furthermore, some implementations may include more than one access server and/or content server.

The access server 110 can be configured to generate an access token for the client device 108. The access token can be used to access applications, content, and/or services on the content server 120 and/or other content servers (now shown). The access server 110 can generate the access token for the client device 108 according to the various techniques disclosed herein.

The content server 120 can be configured to provide applications, content, and/or services that can be accessed from the client device 108. The content server 120 can be configured to establish a secure communication session with the client device 108 in order to access such applications, content, and/or services. The content server 120 can be configured to receive an access token and attestation information from the client device 108 and to make a determination whether to establish the secure communication session with the client device based on the access token and attestation information. The content server 120 and/or the access server 110 can be configured to include information the access token that can be used to bind one or more subsessions to a secure communication session.

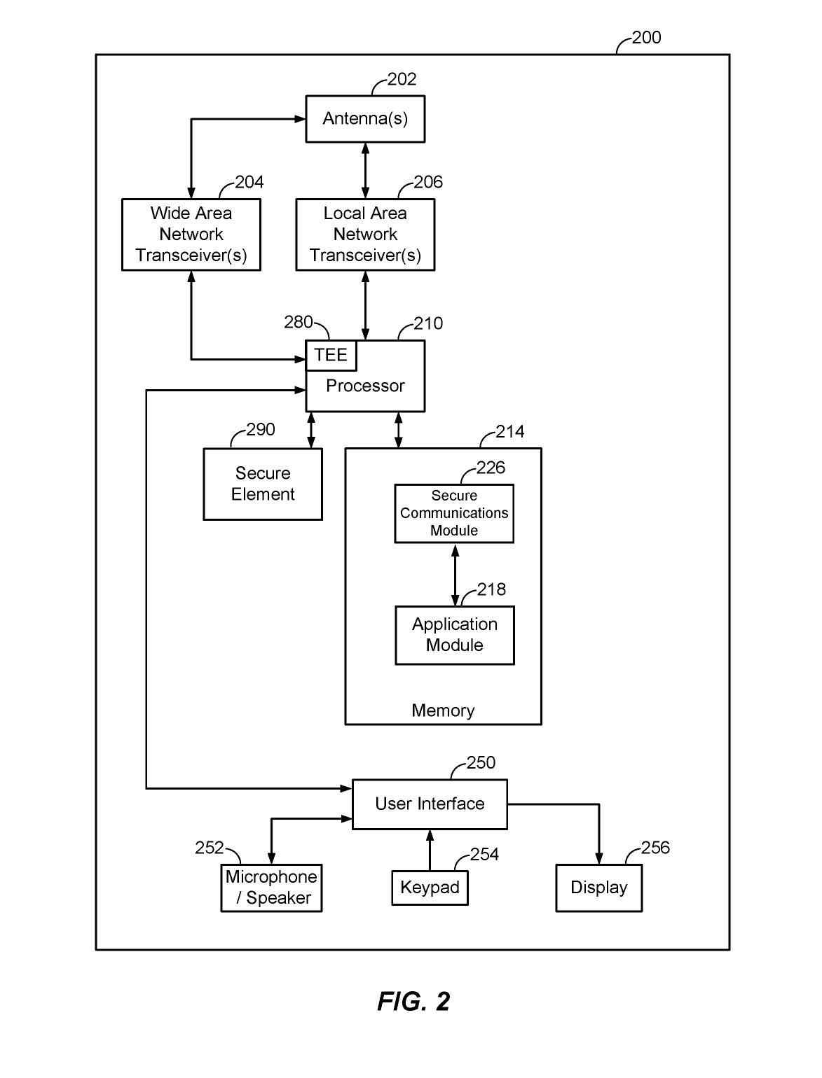

With reference now to FIG. 2, a schematic diagram illustrating various components of an example client device 200, which may be similar to or the same as the client device 108 depicted in FIG. 1 is shown. For the sake of simplicity, the various features/components/functions illustrated in the schematic boxes of FIG. 2 are connected together using a common bus to represent that these various features/components/functions are operatively coupled together. Other connections, mechanisms, features, functions, or the like, may be provided and adapted as necessary to operatively couple and configure a portable wireless device. Furthermore, one or more of the features or functions illustrated in the example of FIG. 2 may be further subdivided, or two or more of the features or functions illustrated in FIG. 2 may be combined. Additionally, one or more of the features or functions illustrated in FIG. 2 may be excluded. In some embodiments, some or all of the components depicted in FIG. 2 may also be used in implementations of one or more of the LAN access points 106a-e and/or WAN access points 104a-c illustrated in FIG. 1.

As shown, the client device 200 may include one or more local area network transceivers 206 that may be connected to one or more antennas 202. The one or more local area network transceivers 206 comprise suitable devices, circuits, hardware, and/or software for communicating with and/or detecting signals to/from one or more of the LAN access points 106a-e depicted in FIG. 1, and/or directly with other wireless devices within a network. In some embodiments, the local area network transceiver(s) 206 may comprise a WiFi (802.11x) communication transceiver suitable for communicating with one or more wireless access points; however, in some embodiments, the local area network transceiver(s) 206 may be configured to communicate with other types of local area networks, personal area networks (e.g., Bluetooth® wireless technology networks), etc. Additionally, any other type of wireless networking technologies may be used, for example, Ultra Wide Band, ZigBee, wireless USB, etc.

The client device 200 may also include, in some implementations, one or more wide area network transceiver(s) 204 that may be connected to the one or more antennas 202. The wide area network transceiver 204 may comprise suitable devices, circuits, hardware, and/or software for communicating with and/or detecting signals from one or more of, for example, the WAN access points 104a-c illustrated in FIG. 1, and/or directly with other wireless devices within a network. In some implementations, the wide area network transceiver(s) 204 may comprise a CDMA communication system suitable for communicating with a CDMA network of wireless base stations. In some implementations, the wireless communication system may comprise other types of cellular telephony networks, such as, for example, TDMA, GSM, WCDMA, LTE etc. Additionally, any other type of wireless networking technologies may be used, including, for example, WiMax (802.16), etc.

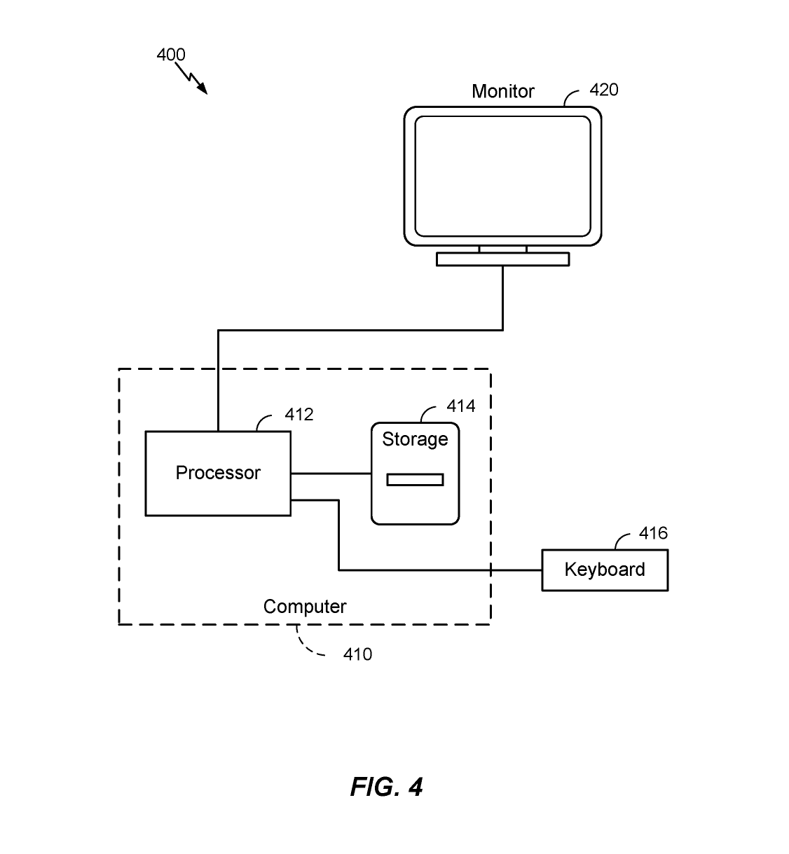

The processor(s) (also referred to as a controller) 210 may be connected to the local area network transceiver(s) 206 and the wide area network transceiver(s) 204. The processor may include one or more microprocessors, microcontrollers, and/or digital signal processors that provide processing functions, as well as other calculation and control functionality. The processor 210 may be coupled to storage media (e.g., memory) 214 for storing data and software instructions for executing programmed functionality within the mobile device. The memory 214 may be on-board the processor 210 (e.g., within the same IC package), and/or the memory may be external memory to the processor and functionally coupled over a data bus. Further details regarding an example embodiment of a processor or computation system, which may be similar to the processor 210, are provided below in relation to FIG. 4.

A number of software modules and data tables may reside in memory 214 and may be utilized by the processor 210 in order to manage both communications with remote devices/nodes (such as the various nodes, the access server 110, and/or the content server 120 depicted in FIG. 1), perform positioning determination functionality, and/or perform device control functionality. As illustrated in FIG. 2, in some embodiments, the memory 214 may include an application module 218 and a secure communications module 226. It is to be noted that the functionality of the modules and/or data structures may be combined, separated, and/or be structured in different ways depending upon the implementation of the client device 200.

The application module 218 may be a process running on the processor 210 of the client device 200, which may request data from one of the other modules of the client device 200. Applications typically run within an upper layer of the software architectures and may be implemented in a rich execution environment of the client device 200, and may include indoor navigation applications, shopping applications, financial services applications, social media applications, location aware service applications, etc. The applications of the application module 218 may make use of the access token to obtain content from the content server 120.

The secure communications module 226 may be a process running on the processor 210 of the client device 200, which may generate requests for access tokens from the access server 110. The secure communications module 226 can also be configured to manage the storage of and access to the access tokens, encryption keys, and attestation information. The secure communications module 226 may be executed on a processor component of the trusted execution environment 280 and/or the secure element 290, where the client device 200 includes such components. The functionality of the secure communications module 226 discussed herein can also be implemented as hardware or a combination of hardware and software. The secure communications module 226 can be implemented one or more application specific integrated circuits (ASICs), programmable logic devices (PLDs), field programmable gate arrays (FPGAs), or other electronic units designed to perform the functions described herein, or a combination thereof.

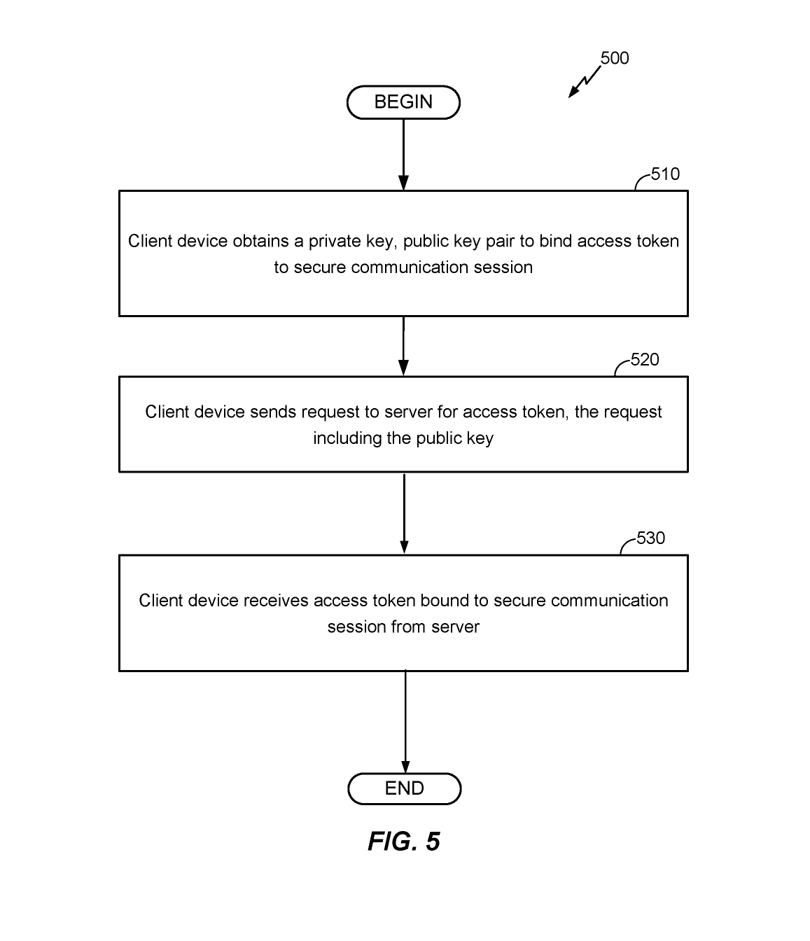

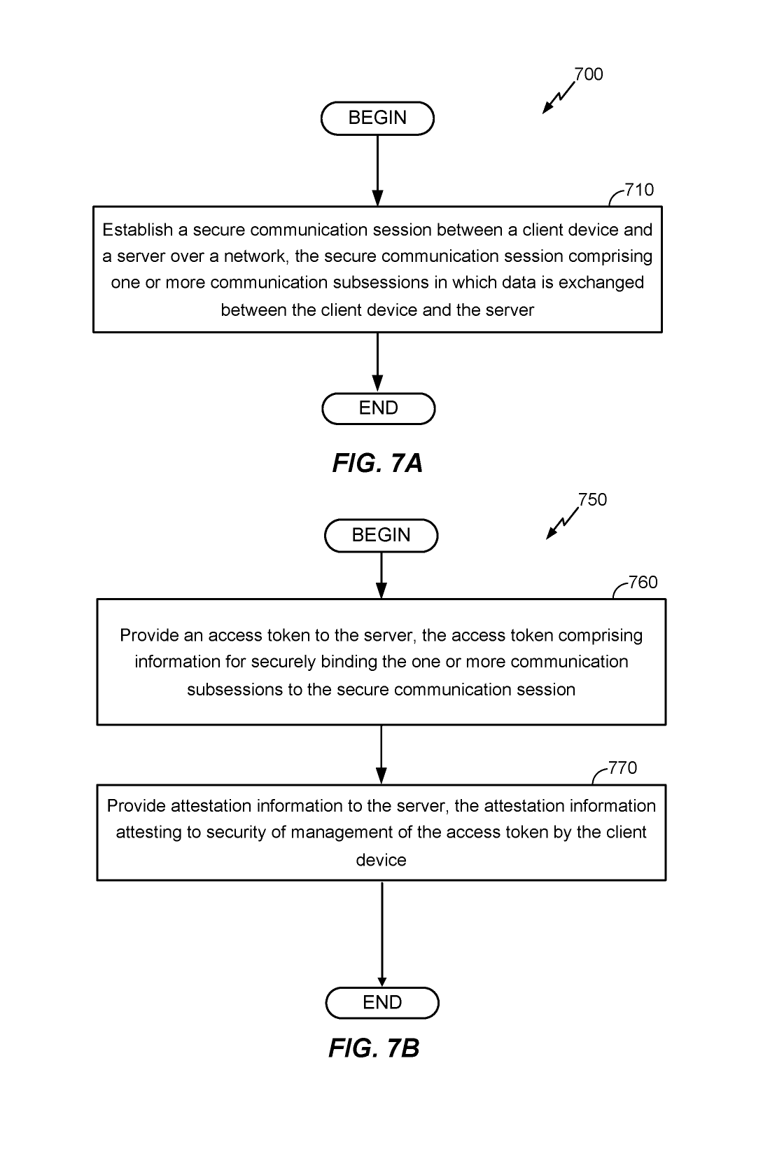

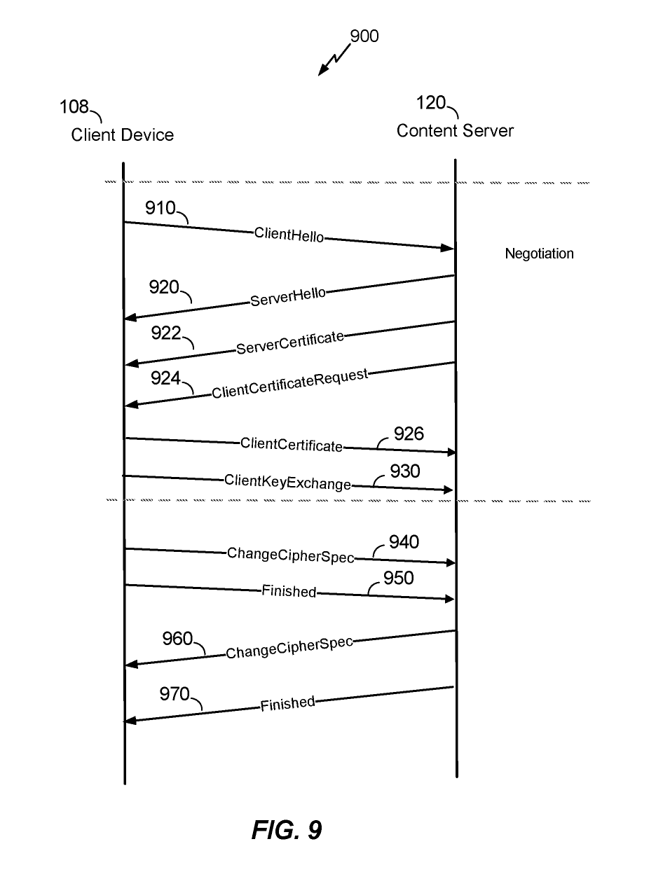

The secure communications module can be used to implement the client-side process illustrated in FIG. 5 for obtaining an access token, and the client-side processes illustrated in FIGS. 7A, 7B, and 9 for establishing a secure communication session with the content server 120, unless otherwise indicated.

The processor 210 may also include a trusted execution environment 280. The trusted execution environment 280 can be implemented as a secure area of the processor 210 that can be used to process and store sensitive data in an environment that is segregated from the rich execution environment in which the operating system and/or applications (such as those of the application module 218) may be executed. The trusted execution environment 280 can be configured to execute trusted applications that provide end-to-end security for sensitive data by enforcing confidentiality, integrity, and protection of the sensitive data stored therein. The trusted execution environment 280 can be used to store encryption keys, access tokens, and other sensitive data.

The client device 200 may include a secure element 290 (also referred to herein as a trusted component). The client device 200 may include the secure element 290 in addition to or instead of the trusted execution environment 280. The secure element 290 can comprise autonomous and tamper-resistant hardware that can be used to execute secure applications and the confidential data associated with such applications. The secure element 290 can be used to store encryption keys, access tokens, and other sensitive data. The secure element 290 can comprise a Near Field Communication (NFC) tag, a Subscriber Identity Module (SIM) card, or other type of hardware device that can be used to securely store data. The secure element 290 can be integrated with the hardware of the client device 200 in a permanent or semi-permanent fashion or may, in some implementations, be a removable component of the client device 200 that can be used to securely store data and/or provide a secure execution environment for applications.

The client device 200 may further include a user interface 250 providing suitable interface systems, such as a microphone/speaker 252, a keypad 254, and a display 256 that allows user interaction with the client device 200. The microphone/speaker 252 provides for voice communication services (e.g., using the wide area network transceiver(s) 204 and/or the local area network transceiver(s) 206). The keypad 254 may comprise suitable buttons for user input. The display 256 may include a suitable display, such as, for example, a backlit LCD display, and may further include a touch screen display for additional user input modes.

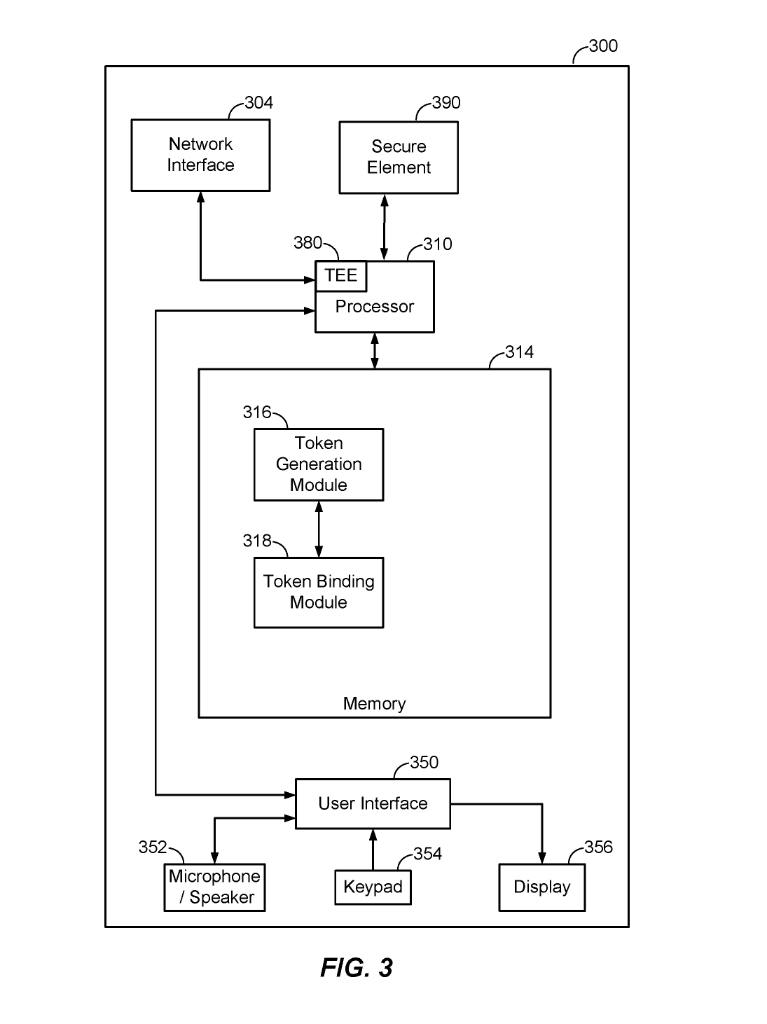

With reference now to FIG. 3, a schematic diagram illustrating various components of an example server 300, which may be similar to or the same as the access server 110 or content server 120 depicted in FIG. 1 is shown. For the sake of simplicity, the various features/components/functions illustrated in the schematic boxes of FIG. 3 are connected together using a common bus to represent that these various features/components/functions are operatively coupled together. Other connections, mechanisms, features, functions, or the like, may be provided and adapted as necessary to operatively couple and configure a portable wireless device. Furthermore, one or more of the features or functions illustrated in the example of FIG. 3 may be further subdivided, or two or more of the features or functions illustrated in FIG. 3 may be combined. Additionally, one or more of the features or functions illustrated in FIG. 3 may be excluded.

As shown, the server 300 may include one or network interfaces 304. The one or more network interfaces 304 comprise suitable devices, circuits, hardware, and/or software for communicating with and/or detecting signals to/from one or more wired or wireless networks. The one or more network interfaces 304 can be used to communicate with the client device via the network 112.

The processor(s) (also referred to as a controller) 310 may be connected to the one or more network interfaces 304, the storage media comprising memory 314, the user interface 350, and the secure element 390. The processor may include one or more microprocessors, microcontrollers, and/or digital signal processors that provide processing functions, as well as other calculation and control functionality. The processor 310 may be coupled to storage media (e.g., memory) 314 for storing data and software instructions for executing programmed functionality within the mobile device. The memory 314 may be on-board the processor 310 (e.g., within the same IC package), and/or the memory may be external memory to the processor and functionally coupled over a data bus. Further details regarding an example embodiment of a processor or computation system, which may be similar to the processor 310, are provided below in relation to FIG. 4.

A number of software modules and data tables may reside in memory 314 and may be utilized by the processor 310 in order to manage both communications with remote devices/nodes, perform positioning determination functionality, and/or perform device control functionality. As illustrated in FIG. 3, in some embodiments, the memory 314 may include a token generation module 316 and/or a token binding module 318. It is to be noted that the functionality of the modules and/or data structures may be combined, separated, and/or be structured in different ways depending upon the implementation of the server 300. Furthermore, The functionality of the token generation module 316 and/or a token binding module 318 discussed herein can also be implemented as hardware or a combination of hardware and software. The token generation module 316 and/or a token binding module 318 can be implemented one or more application specific integrated circuits (ASICs), programmable logic devices (PLDs), field programmable gate arrays (FPGAs), or other electronic units designed to perform the functions described herein, or a combination thereof.

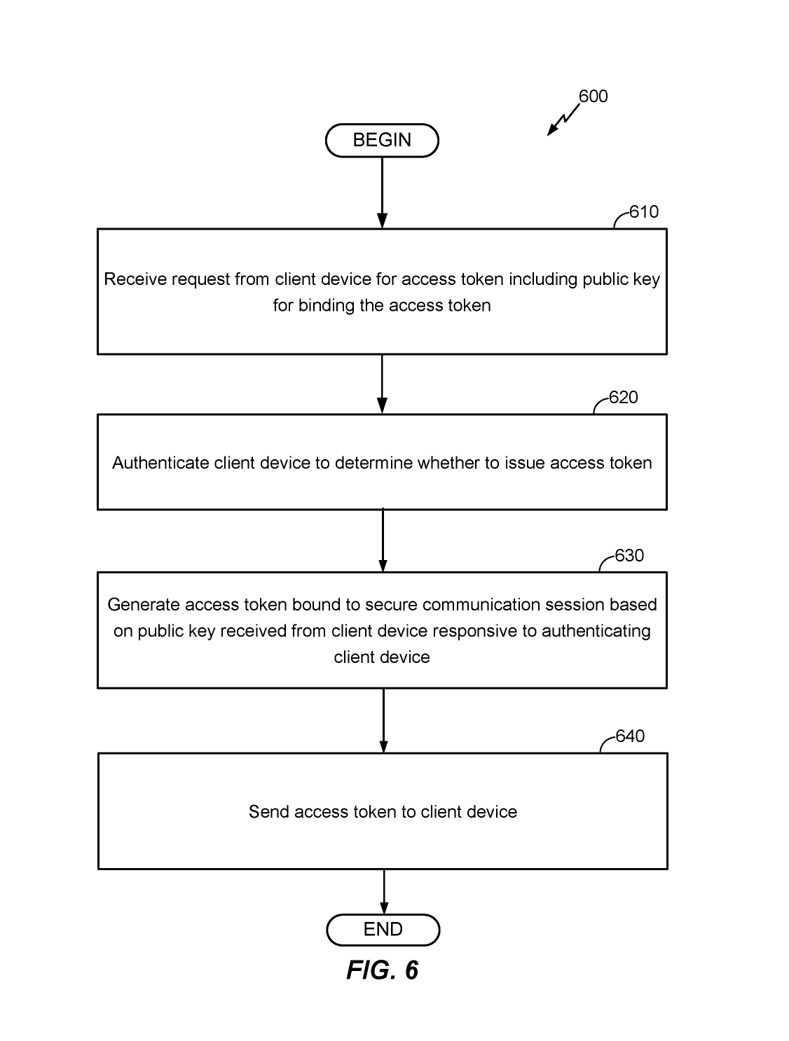

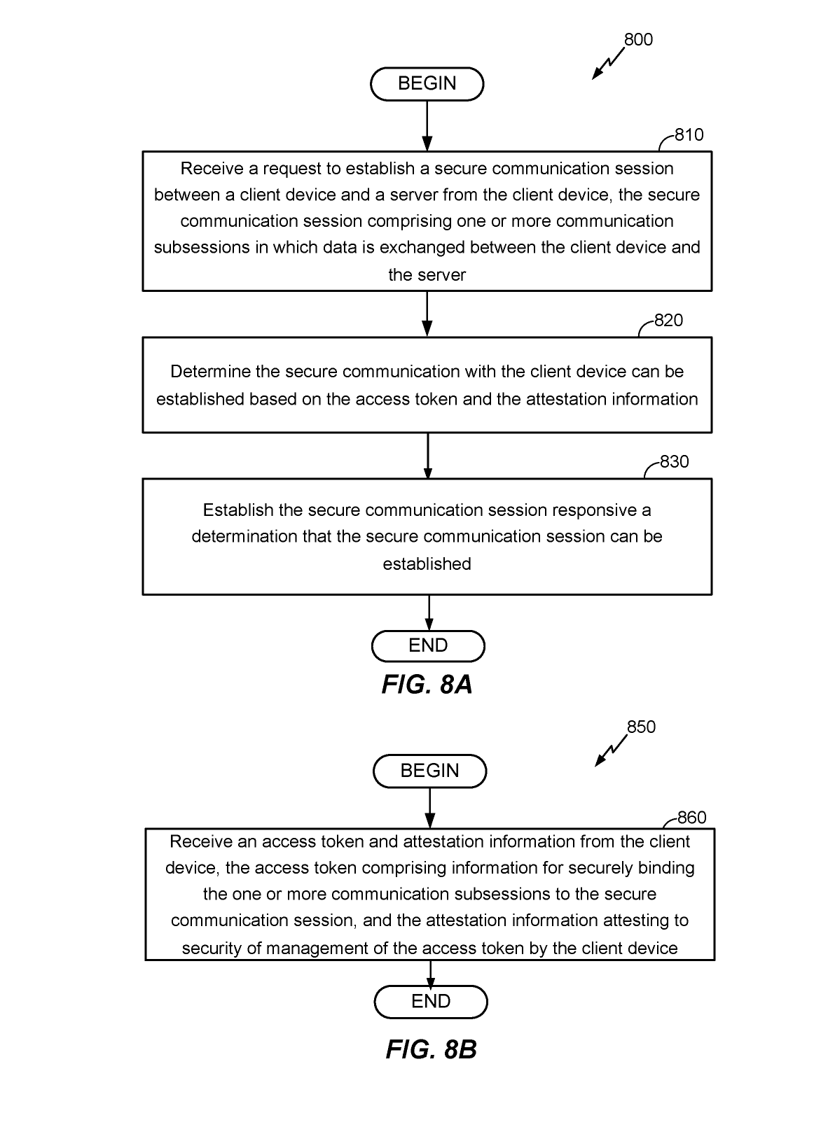

The token generation module 316 may be a process running on the processor 310 of the server 300, which may generate an access token for a client device 108 according to the various techniques disclosed herein. The token binding module 318 may be a process running on the processor 310 of the server 300, which can use information included in the access token to securely bind the access token to a secure communication session associated with the client device 108, according to the various techniques disclosed herein. For example, the token generation module 316 and the token binding module 318 can be used to implement the server-side process illustrated in FIG. 6 for generating an access token and for using information included in the access token to securely bind one or more communication subsessions to a secure communication session and the server-side processes illustrated in FIGS. 8A, 8B, and 9 for establishing a secure communication session with the client device 108, unless otherwise indicated.

The processor 310 may also include a trusted execution environment 380. The trusted execution environment 380 can be implemented as a secure area of the processor 310 that can be used to process and store sensitive data in an environment that is segregated from the rich execution environment in which the operating system and/or applications (such as those of the application module 218) may be executed. The trusted execution environment 380 can be configured to execute trusted applications that provide end-to-end security for sensitive data by enforcing confidentiality, integrity, and protection of the sensitive data stored therein. The trusted execution environment 380 can be used to store encryption keys, access tokens, and other sensitive data.

The server 300 may include a secure element 390 (also referred to herein as a trusted component). The server 300 may include the secure element 390 in addition to or instead of the trusted execution environment 380. The secure element 390 can comprise autonomous and tamper-resistant hardware that can be used to execute secure applications and the confidential data associated with such applications. The secure element 390 can be used to store encryption keys, access tokens, and other sensitive data. The secure element 390 can comprise a Near Field Communication (NFC) tag, a Subscriber Identity Module (SIM) card, or other type of hardware device that can be used to securely store data. The secure element 390 can be integrated with the hardware of the server 300 in a permanent or semi-permanent fashion or may, in some implementations, be a removable component of the server 300 that can be used to securely store data and/or provide a secure execution environment for applications.

The server 300 may further include a user interface 350 providing suitable interface systems, such as a microphone/speaker 352, a keypad 354, and a display 356 that allows user interaction with the server 300. The microphone/speaker 352 provides for voice communication services (e.g., using the one or more network interfaces 304). The keypad 354 may comprise suitable buttons for user input. The display 356 may include a suitable display, such as, for example, a backlit LCD display, and may further include a touch screen display for additional user input modes.

Performing the procedures described herein may be facilitated by a processor-based computing system. With reference to FIG. 4, a schematic diagram of an example computing system 400 is shown. The computing system 400 may be housed in, for example, a handheld mobile device such as the client device 108 and client device 200 of FIGS. 1 and 2, respectively, or may comprise part or all of access server 110, content server 120, and server 300, nodes, access points, or base stations such as the WAN access points 104a-c and 106a-e depicted in FIGS. 1 and 3. The computing system 400 includes a computing-based device 410 such as a personal computer, a specialized computing device, a controller, and so forth, that typically includes a central processor unit (CPU) 412. In addition to the CPU 412, the system includes main memory, cache memory and bus interface circuits (not shown). The computing-based device 410 may include a mass storage device 414, such as a hard drive and/or a flash drive associated with the computer system. The computing system 400 may further include a keyboard, or keypad, 416, and a monitor 420, e.g., a CRT (cathode ray tube) or LCD (liquid crystal display) monitor, that may be placed where a user can access them (e.g., a mobile device's screen).

The computing-based device 410 may be configured to facilitate, for example, the implementation of one or more of the procedures described herein (including the procedures to disseminate, collect, and/or and manage antenna information, the procedures to perform location determination operations, etc.) The mass storage device 414 may thus include a computer program product that when executed on the computing-based device 410 causes the computing-based device to perform operations to facilitate the implementation of the procedures described herein. The computing-based device may further include peripheral devices to enable input/output functionality. Such peripheral devices may include, for example, a CD-ROM drive and/or flash drive, or a network connection, for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), a DSP processor, or an ASIC (application-specific integrated circuit) may be used in the implementation of the computing system 400. Other modules that may be included with the computing-based device 410 are speakers, a sound card, a pointing device, e.g., a mouse or a trackball, by which the user can provide input to the computing system 400. The computing-based device 410 may include an operating system.

FIG. 5 is a flow diagram of an example process 500 in which a client device can obtain an access token from an access server. The process 500 can be implemented by the client device 108 illustrated in FIG. 1 or the client device 200 illustrated in FIG. 2. The access token can be bound to a secure communication session such that a malicious party obtaining the access token would not be able to utilize the access token without also obtaining a private key stored on the client device 108. The private key can be stored in a memory associated with the trusted execution environment 280 or the secure element 290 of the client device 108 to prevent malicious parties from obtaining the private key. The access token, once obtained, may also be stored in the memory associated with the trusted execution environment 280 or the secure element 290 of the client device 108 as well. The client device 108 can be configured to provide attestation information to the content server 120 in addition to the access token when attempting to obtain access to applications, content, and/or services provided by the content server 120. The attestation information can provide information regarding the management of the private keys by the client device 108, and the content server 120 can make a determination whether to establish a secure communication session with the client device 108 based on the access token and the attestation information. Examples of processes illustrated in FIGS. 7A, 7B, 8A, 8B, and 9 illustrate these concepts and are discussed in detail below.

Returning now to FIG. 5, the client device 108 can obtain a private key—public key pair that can be used to bind an access token to a secure communication session (stage 510). The client device 108 can be configured to generate the private key—public key pair to be used for a particular secure communication session. The client device 108 can be configured to generate the private key—public key pair in the trusted execution environment 280 or the secure element 290 of the client device 108 to help ensure that the private key remains secret. In some implementations, the client device 108 may generate the private key in a rich execution environment in which the operating system and non-trusted applications may be executed by the client device 108 if the client device lacks a trusted execution environment 280 or a secure element 290. The attestation information provided by the client device 108 with the access token can indicate whether the private key—public key pair was generated and stored in a trusted execution environment 280 or a secure element 290, and the content server 120 can use this management information to determine whether to establish a secure communication session with the client device 108.

The client device 108 can send a request to the access server 110 for an access token that can be used to access applications, content, and/or services provided by the content server 120 (stage 520). The request can include the public key obtained in stage 510. The private key of the key pair should be maintained as a secret by the client device 108. The public key of the key pair can be used by the access server 110 to bind the access token to the secure communication session. The actions that may be taken by the access server 110 when generating the access token are discussed in detail below with regard to the process 600 illustrated in FIG. 6.

The client device 108 can receive the access token from the access server 110 (stage 530). The client device 108 can be configured to store the access token in a memory associated with the trusted execution environment 280 or the secure element 290 of the client device 108 to help prevent the theft of the access token by a malicious third party. However, the client device 108 may be configured to store the access token in a memory accessible by the rich execution environment while maintaining the private key associated with the access token in the memory associated with the trusted execution environment 280 or the secure element 290. In some implementations, the client device 108 may store the access token and/or the encryption keys in an rich execution environment. However, the client device 108 can be configured to encrypt or otherwise encode the access token and/or the encryption keys in an rich execution environment to prevent unauthorized access to the access token and the private key associated with the access token.

FIG. 6 is a flow diagram of an example process 600 in which a client device can obtain an access token from an access server. The process 600 can be implemented by the access server 110 illustrated in FIG. 1 or server 300 illustrated in FIG. 3. As discussed above, the functionality of the access server 110 and the content server 120 can be implemented in the same server or set of servers in some implementations.

The access server 110 can receive a request from the client device 108 (or client device 200) for an access token (stage 610). The request can include a public key from a private key-public key pair obtained by the client device 108 which is associated with a secure communication session to which the access token is to be bound. Binding the access token to the secure communication session using the public key means that a client device 108 requires both the access token and the private key associated with the public key used to bind the access token in order for the client device 108 to be able to establish a secure communication session with the content server 120 using the access token. For example, the content server 120 can send a nonce value to the client device 108 that the client device 108 can digitally sign using the private key. The digital signature value can be returned to the content server 120, which can use the public key associated with access token to validate the digital signature of the nonce value. If the digital signature cannot be validated, the content server 120 can refuse the establish the communication session with the client device 108.

The access server 110 can authenticate the client device 108 to determine whether to issue the access token (stage 620). The request received from the client device 108 can include information that can be used to identify the client device 108 to the access server 110. For example, the request may be signed by a private key associated with the client device 108 and/or a private key associated with the trusted execution environment 280 or the secure element 290 of the client device 108. The request may also include authentication credentials, such as a username and password combination, or other information that the access server 110 can use to authenticate the client device 108. The access server 110 can be configured to authenticate the client device 108 with respect to a specific content server or application, content, and/or service provided by that content server 120. Furthermore, the access server 110 can also be configured to authenticate the user with respect to more than one content server. In some embodiments, the access server 110 may issue separate access tokens to the client device 108 for each content server 120, and the client device 108 can use each access token to establish a secure communication session with a particular content server 120. In other embodiments, the access server 110 may issue an access token that may be used to establish a secure communication session with more than one content server.

The access server 110 can generate an access token which is bound to a particular secure communication session based on the public key received from the client device 108 responsive to authenticating the client device 108 (stage 630). The access server 110 can be configured to incorporate the public key into the access token and/or to sign the access token using the public key provided by the client device 108. The access server 110 can also be configured to incorporate an identifier into the access token that can be mapped to the client device 108 and/or the private key associated with the client device 108 is associated with the public key. For example, the access server 110 can encrypt information using the public key provided by the client device 108 and insert the encrypted information into the token. The access server 110 can also be configured to store the unencrypted of the information in a database that maps the unencrypted information to the access token and the client device 108. The access server 110 can make this database accessible to the content server 120. The client device 108 can later prove to the content server 120 that the content server 120 possesses the private key from the private key—public key pair used to generate the access token by decrypting the encrypted information included in the token and providing the unencrypted information to the content server 120. This information does not need to be send in the clear over the network 112, which could impact the security of the access token. Instead, the client device 108 can be configured to encrypted the decrypted information using a public key associated with the content server 120 before sending the information to the content server 120. The content server 120 can decrypt the information provided by the client device 108 using the content server's private key, and the content server can compare the information provided by the client server that the client device 108 extract from the token to the unencrypted data in the database maintained by the access server 110 to determine whether the client device 108 is in possession of the private key. The access server 110 and the content server 120 can provide a secure interface for communicating the access token information over the network 112 so that the security of the token information is not compromised. The content server 120 can also be configured to require that the client device 108 digitally sign a nonce value generated by the content server 120 each time that the client device 108 attempts to establish a subsession connection associated with a secure communication session with the content server 120. The client device 108 can digitally sign the nonce value with the private key of the private key-public key pair used to generate the access token. The client device can return the digital signature of the nonce value to the content server 120. The content server 120 can validate the digital signature using the public key of the private key-public key pair used to generate the access token. If the content server 120 cannot validate the digital signature provided by the client device 108, the content server 120 can be configured to halt the secure communication session with the client device 108.

The access server 110 can send the access token to the client device 108 over the network 112 (stage 640). The access server 110 can send the access token to the client device 108 over the public network, because both the token and the private key held by the client device 108 should be required in order for the access token to be used to obtain access to content, services, and/or services provided by the content server 120. The access server 110 can also be configured to encrypt the access token prior to sending the access token to the client device 108. For example, the access server 110 can be configured to encrypt the access token using a public key associated with the client device 108, which may be different than the public key used to bind the token to the secure communication session, and send the encrypted token to the client device 108. The client device 108 can then use the appropriate private key to decrypt the encrypted access token.

FIG. 7A is a flow diagram of an example process 700 in which a client device can establish a secure communication session with a content server. The process illustrated in FIG. 7B is a flow diagram of an example process which includes stages which can be used to implement stage 710 of the process 700 illustrated in FIG. 7A. The processes illustrated in FIGS. 7A and 7B can be implemented by the client device 108 unless otherwise specified. The secure communication subsession can be a Transport Layer Security (TLS) protocol communication session or can be other types of secure communication subsession where the client device 108 can provide attestation information along with an access token or other security credentials to the content server 120, and the attestation information can provide information about the client device 108 to the content server 120 and information as to how the client device 108 manages the access token or other security credentials.

The client device 108 can establish a secure communication session between a client device and a content server 120 over a network (stage 710). The secure communication session can include one or more communication subsessions in which data is exchanged between the client device 108 and the content server 120. Data exchanged between the client device 108 and the content server 120 can be encrypted using various encryption techniques. The client device 108 and the content server 120 can be configured to undertake a negotiation process as part of stage 710 in which the client device 108 and the content server 120 exchange information regarding the encryption capabilities of the client device 108 and the content server 120. During this negotiation process, the client device 108 and the content server 120 can exchange information that can be used to generate the encryption keys that can be used by the client device 108 and the content server 120 to encrypt data to be exchanged during the secure communication session. The client device 108 and the content server 120 can also be configured to determine a cipher suite to be used to encrypt the communications between the client device 108 and the content server 120 during the secure communication session during the negotiation process. The client device 108 and the content server 120 can also be configured to perform additional actions in addition to and/or instead of one or more of the actions discussed herein during negotiation phase in which the secure communication session is established.

The client device 108 can be configured to select an appropriate cipher suite to be used for encrypting communications with the content server 120 based on an estimated lifespan of the communication subsessions to be associated with the secure communication session. The client device 108 can be configured to select a technique for signing the access token and/or for performing other cryptographic operations that the client device 108 should be able to complete within the estimated lifespan of the communication subsession. A subsession connection may be fleeting and the cryptographic operations performed on data exchanged for such a subsession connection should be able to completed within the estimated lifespan of such as connection. The client device 108 can also be configured to receive policy information from the server during the negotiation phase that indicates preferred encryption techniques to be used for signing data and/or other cryptographic operations and to select an appropriate cryptographic technique or techniques based on the server policy information.

The client device 108 can provide an access token and attestation information associated with the access token to the content server 120 during stage 710. Information included in the access token can be used to bind the secure communication session to the client device 108. FIGS. 5 and 6 illustrate example processes in which an access token may be bound to a secure communication session. In some implementations, the client-side process illustrated in FIG. 5 may be included in stage 710 of the process illustrated in FIG. 7A, and the client device 108 may obtain the access token from the access server 110, and the access token can then be associated with secure communication identifier by the access server 110. The binding process can use a public key uniquely associated with the client device 108 that can be used to ensure that the access token can only be used by client device 108, which is in possession of the private key corresponding to the public key used to bind the access token. The example binding processes illustrated herein are examples of some of the types of binding processes that may be used to bind the access token to the secure communication session and are not intended to limit the techniques disclosed herein to such processes. The client device 108 can also provide attestation information that can provide information about that client device 108 and how the client device manages the access token and the private keys. The attestation information is discussed in detail below with respect to FIG. 7B.

Stages 760 and 770 of the process 750 illustrated in FIG. 7B can be used to implement at least a portion of stage 710 of the process 700 illustrated in FIG. 7A. The client device 108 can be configured to provide an access token to the server (stage 760). Information included in the access token can be used to securely bind the one or more communication subsessions to the secure communication session. The access token can be issued by the access server 110 discussed above. The access token can be used to bind one or more communication subsessions to a secure communication session to ensure that a malicious third party cannot obtain the token and attempt to access content on the content server 120 using the access token. The access token can be bound to the secure communication session in multiple ways. One way that the access token may be bound to the secure communication session is to generate the access token prior to or as the secure communication session is being established and to incorporate into the access token a unique identifier associated with the secure communication session, such a public key of a private key-public key pair associated with the client device 108. The content server 120 can be configured to send a nonce value to the client device 108. The client device 108 can digitally sign the nonce value using the private key of the client device 108. The content server 120 can then verify that the client device 108 is in possession of the private key by verifying the digital signature of the nonce value using the public key from the access token. The access token can also be mapped to a unique identifier associated with the secure communication session and the mapping can be stored in a database that the content server 120 can access whenever the client device 108 attempts to establish a communication subsession associated with the secure communication session with the content server 120.

FIGS. 5 and 6 discussed above provide an example of client-side and server-side processes that may be used to bind the secure communication session with the access token. According to the processes discussed in FIGS. 5 and 6, the access token can be associated with the client device 108 utilizing the public key of a private key—public key pair associated with the client device 108. The client device 108 ideally stores the private key in a memory associated with the trusted execution environment 280 or the secure element 290. The client device 108 must possess both the access token and the associated private key in order to make use of the access token to establish a secure communication session with the content server 120.

The client device 108 can also be configured to provide attestation information to the content server 120 (stage 770). The attestation information can attest to security of management of the access token by the client device 108. The client device 108 can take various measures to securely manage the private keys associated with the client device 108 and the access tokens utilized by the client device 108. As discussed above, some client devices may include a trusted execution environment or trusted component, and the client device 108 can be configured to store private keys and the access tokens used by the client device 108 in a memory associated with the trusted execution environment or trusted component to decrease the likelihood of a malicious third party obtaining these private keys and access tokens, and using these keys and access tokens to impersonate an authorized user to obtain access to applications, content, and/or services provided by the content server 120. The attestation information can give the content server 120 information about the client device 108 and how the client device 108 manages the private keys and access tokens used by the client device 108. The content server 120 can use the attestation information to determine whether to establish a secure communication session with the client device 108. The client device 108 can be configured to send an indicator to the content server 120 that the client device 108 will not send attestation information to the content server 120 for subsequent communication sessions once the attestation information has been provided to the content server 120. The content server 120 can be configured to store the attestation information provided by the client device 108 and to use the attestation information in the future when establishing future sessions with the client device 108. The content server 120 can be configured to respond with an indicator that indicates whether the content server 120 accepts the suppression of the sending of the attestation information in the future. The client device 108 can be configured to store an indicator indicating whether the content server 120 accepts the suppression of the attestation information for future sessions with the client device 108. If the content server 120 accepts the suppression of the attestation information for future sessions with the client device 108, the client device 108 can be configured to not send the attestation information to the content server 120 when establishing a new session with the content server 120. If the content server 120 does not accept the suppression of the attestation information, the client device 108 can continue to send the attestation information when establishing a new session with the content server 120. The client device 108 can also be configured to send the attestation information to the content server 120 responsive to the there being a change to the attestation information since the attestation information was last sent to the content server 120 when establishing a new session with the content server 120 regardless of whether the attestation information suppression has been accepted by the content server 120.

The attestation information can include information indicating whether the access tokens and the private keys are stored in memory associated with a trusted execution environment or trusted component of the client device 108. The attestation information can also include other information about the client device 108, such as the hardware and/or firmware information about the client device 108, operating system version information, information identifying trusted applications installed on the client device 108 that utilize the trusted execution environment or trusted component of the client device 108, information identifying applications installed on the client device 108 that do not operate in the rich execution environment, and/or version information for trusted and untrusted applications.

In some implementations, the client device 108 can provide multi-layered attestation information to the content server 120. In some implementations, the client device 108 can provide attestation information at an application layer and at a socket layer. The attestation information provided at the application layer and the socket layer can potentially differ, and the content server 120 can be configured to make a determination whether to allow the secure communication session to be established based on the application layer and the socket layer attestation information. For example, an application on the client device 108, such as a web browser or other application configured to establish a secure communication session with the content server 120, may be configured to provide application layer attestation information.

FIG. 8A is a flow diagram of an example process 800 in which a server can establish a secure communication session with a client device. The process illustrated in FIG. 8B is a flow diagram of an example process which includes stages which can be used to implement stage 810 of the process 800 illustrated in FIG. 8A. The process illustrated in FIGS. 7A and 7B can be implemented by the content server 120 and/or by the access server 110 unless otherwise specified.

The content server 120 can receive a request from the client device 108 to establish a secure communication session between the client device 108 and the content server 120 (stage 810). The secure communication session can include one or more communication subsessions in which data is exchanged between the client device 108 and the content server 120. The secure communication subsession can be a Transport Layer Security (TLS) protocol communication session or can be other types of secure communication subsession where the client device 108 can provide attestation information along with an access token or other security credentials to the content server 120, and the attestation information can provide information about the client device 108 to the content server 120 and information as to how the client device 108 manages the access token or other security credentials. FIG. 8B illustrates a process that can be used to implement at least a portion of stage 810 in which the content server 120 receives an access token and attestation information from the client device 108.

The content server 120 can determine whether the secure communication session can be established with the client device 108 based on information provided by the client device 108 (stage 820). The content server 120 can make the determination whether the secure communication session can be established based on the access token and the attestation information received from the client device 108. With respect to the access token, the content server 120 can be configured to determine whether the access token is bound to a secure communication session or is a generic bearer token that is not bound to a particular secure communication session. The content server can access policy information associated with applications, content, and/or services to which the access token would provide access to determine whether the access token is required to be bound to a particular secure communication session. If the policy indicates that the access token must be bound to a secure communication session, and the token is unbound, the content server 120 can be configured to terminate the secure communication session. If the access token is bound to a secure communication session, the content server 120 can compare a token ID in the token with a session ID associated with the secure communication session. If the token ID and the session ID differ, the content server 120 may determine that the access token is not in the possession of the client device 108 to which it was issued and can terminate the secure communication session. The access token may also include information encrypted using a public key of the client device 108. The content server 120 can be configured to obtain an unencrypted version of this information from the access server 110, which issued the encryption token, and an unencrypted version of this string from the client device 108. If the unencrypted version obtained from the client device 108 is the same as that obtained from the access server 110, then the client device 108 is in possession of the private key associated with the public key that was bound to the access token. If the unencrypted version provided by the client device 108 does not match that obtained from the access server 110, the content server 120 can be configured to terminate the secure communication session. The content server 120 can be configured to perform additional processing with respect to the access token to determine whether the establish the secure communication session with the client device 108 in addition to or instead of one or more of those discussed herein.

The content server 120 can also be configured to send a nonce value to the client device 108. The client device 108 can be configured to digitally sign the nonce value using the private key from the private key-public key pair used to generate the access token. The content server 120 can be configured to verify the digital signature using the public key from the private key-public key pair used to generate the access token. If the digital signature cannot be validated, the content server 120 can be configured to terminate the secure communication session.

The content server 120 can also be configured base the determination on whether the secure communication session can be established based on the attestation information provided by the client device 108. The attestation information can provide information regarding the configuration of the hardware and/or the software of the client device 108, including versions of the software and firmware utilized by the client device 108. The attestation information can also include information such as the types and version of secure communication protocols and encryption protocols supported by the client device. The content server 120 can compare the attestation information to the policy information associated with the application-specific policy information to determine whether to allow access to the applications, content, and/or services provided by the content server 120. The application-specific policy information can include rule related to the hardware and/or software of the client device 108. For example, the policy rules may prohibit establishing a secure communication session with certain types of client device 108 where the hardware does not provide a trusted execution environment 280, a secure element 290, or other secure environment for storing the encryption keys and/or the access tokens. The policy rules may also require that the client device 108 have a certain version number or higher or a particular patch for the operating system software installed on the client device 108, because those version numbers or the patch have fixed a security issue with the operating system of the client device 108. The policy rules may also require that the client device 108 not have certain software applications or versions of software applications installed that are known to pose a security threat or outdated versions.

At least a portion of the attestation information may be digitally signed using the private key associated with the client device 108 and/or with a trusted execution environment and/or the secure element 290 of the mobile device. The content server 120 can use the corresponding public key associated with the client device 108 to verify the digital signature associated with the portion of the attestation information, which can be used to confirm that the client device 108 is in possession of the private key. If the content server 120 cannot verify the digital signature, then the client device 108 may not be in possession of the private key associated with the access token, and the content server 120 can be configured to terminate the secure communication session with the client device 108.

The content server 120 can also be configured to make a determination as whether to establish the secure communication session with the client device 108 based on assertions made by the client device 108 regarding the management of the access token and/or the private keys on the client device 108. For example, the content server 120 may determine that the policy information requires that the client device 108 store the private keys and/or attestation tokens in a secure memory location such as in the trusted execution environment 280 or the secure element 290, and the content server 120 may terminate a session with the client device 108 if the client device 108 does not assert that the encryption keys and/or the access tokens have been stored in such a secure memory location.

The content server 120 can also be configured obtain information from the local data, from the access server 110, or another third party server (not shown) that can be used to confirm various aspects of the attestation information provided by the client device 108 and/or to obtain additional information that can be used to make a determination. For example, the content server 120 can be configured to obtain hardware and/or firmware specifications for the type of device used to implement the client device 108 to determine whether the device provides the appropriate level of hardware and/or software security for storage and management of the private keys and/or the access tokens. The content server 120 may also be able to obtain additional information from the access server 110 which can be used to confirm the assertions made by the client device 108 in the attestation information. The content server 120 may also obtain other information about the client device 108 from these or other sources to determine whether the secure communication session can be established by the client device.

As discussed above, the client device 108 can be configured to send an indicator to the content server 120 that the client device 108 will not send attestation information to the content server 120. The content server 120 can be configured to store the attestation information provided by the client device 108 and to use the attestation information in the future when establishing future sessions with the client device 108. The content server 120 can be configured to respond with an indicator that indicates whether the content server 120 accepts the suppression of the sending of the attestation information in the future. If the content server 120 accepts the suppression of the attestation information for future sessions with the client device 108, the client device 108 can be configured to not send the attestation information to the content server 120 when establishing a new session with the content server 120. If the content server 120 does not accept the suppression of the attestation information, the client device 108 can continue to send the attestation information when establishing a new session with the content server 120.

The content server 120 can establish the secure communication session with the client device 108 responsive to determining that the secure communication session can be established (stage 830). If the content server 120 determines that the secure communication session cannot be established for any reason, the content server 120 can be configured to tear down the secure communication session between the client device 108 and the content server 120. The content server 120 can also be configured to send a message to the client device 108 indicating that the secure communication session could not be established. The client device 108 can be configured to receive and process this message and may be configured to provide an error message to a user of the client device 108 via a user interface of the client device indicating that the secure communication session could not be established.

Stage 860 of the process 850 illustrated in FIG. 8B can be used to implement at least a portion of stage 810 of the process 800 of FIG. 8A. The content server 120 can receive an access token and attestation information from the client device 108 (stage 860). The access token can securely bind the one or more communication subsessions to the secure communication session, and the attestation information can attest to the security management of the access token by the client device 108. As discussed above, the access token may be generated by a separate access server 110 or the functionality of the access server 110 may be incorporated into the content server 120 and the content server 120 may generate the access token and bind it to the secure communication session as the secure communication session is established. The attestation information can attest to security of management of the access token by the client device 108. The attestation information can give the content server 120 information about the client device 108 and how the client device 108 manages the private keys and access tokens used by the client device 108. The content server 120 can use the attestation information to determine whether to establish a secure communication session with the client device 108.

FIG. 9 is a signal flow diagram illustrating example interactions between a client device and content server according an example implementation. The example illustrated in FIG. 10 can be used to implement stage 710 of the FIG. 7A, stages 760 and 770 of FIG. 7B, the stages of the processes illustrated in FIGS. 8A and 8B. In the example illustrated in FIG. 9, the client device 108 initiates a request to establish a secure communication session with the content server 120 using Transport Layer Security (TLS) protocol and the signal flow diagram illustrates the stages of the handshake process that occurs between the client device 108 and the content server 120 to establish a TLS connection for a TLS session between the client device 108 and the content server 120. While the example embodiment illustrated in FIG. 9 utilizes the TLS protocol, the techniques disclosed herein can be used to establish secure communication sessions using other secure communication protocols.

The handshake process 900 can be used to exchange various parameters that will be used to establish the TLS session between the client device 108 and the content server 120. The handshake process starts with a negotiation phase that includes stages 910, 920, and 930. The client device 108 and the content server 120 can be configured to undertake a negotiation process in which the client device 108 and the content server 120 exchange information regarding the encryption capabilities of the client device 108 and the content server 120. During this negotiation process, the client device 108 and the content server 120 can exchange information that can be used to generate the encryption keys that can be used by the client device 108 and the content server 120 to encrypt data to be exchanged during the TLS session. The client device 108 and the content server 120 can also be configured to determine a cipher suite to be used to encrypt the communications between the client device 108 and the content server 120 during the TLS session.

The client device 108 can send a “ClientHelloMessage” (stage 910) to the content server 120. The ClientHelloMessage can include various parameters that can be used by the content server 120 to establish the TLS session with the client device 108. The ClientHelloMessage parameters can include an indicator identifying a highest TLS token binding protocol version supported by the client device 108. The parameters can also include a list of cryptographic algorithms that are supported by the client device 108. The parameters can also include a list of list of compression methods that are supported by the client device 108.

In one embodiment, the parameters can may be represented using a TokenBindingKeyParameters structure, and example of which follows this paragraph. The structure can include a token_binding_version field in which the version of the token binding protocol being used can be specified. Other parameters associated with the token binding protocol may be specified in the key_parameters_list field. The attestation_length_bytes field can be used to indicate a length of the attestation information included in the attestation_data field. The suppress_attestation field can be used to indicate that the client device has requested that sending of the attestation information be suppressed after the first time that the attestation information has been sent to the content server 120. In other implementations, the suppress_attestation field may be implemented in the ClientHelloMesssage rather than in the TokenBindingKeyParameters.

```
struct {
    ProtocolVersion token_binding_version;
    TokenBindingKeyParameters key_parameters_list<1..2 \hat{ } 8−1>;
    attestation_length_bytes<1..2 \hat{ } 8−1>;
    attestation_data<1..2 \hat{ } (8*attestation_length_bytes)>;
    Boolean suppress_attestation;
} TokenBindingParameters;
```

The ClientHelloMessage can also include an access token and attestation information as parameters. Information included in the access token can be used to securely bind one or more TLS connections to the TLS session to prevent a malicious third party from obtaining the access token and presenting the access token to web services, such as those provided by the content server 120, in order to impersonate an authorized user of those services. The ClientHelloMessage can also include a session identifier (also referred to herein as a session ID or TLS session ID) that can be used if the client is attempting to resume an existing TLS session. If the session ID is valid and represents an existing session, the client device 108 and the content server 120 can avoid having to engage in the steps discussed below for establishing session keys and the client device 108 and the content server 120 can resume the session utilizing the existing session keys.

The content server 120 can respond to the ClientHelloMessage with a ServerHelloMessage (stage 920). The ServerHelloMessage can include the chosen cipher suite, compression method, and version of TLS to be used for the TLS session. The selected version of TLS can support a version of the TLS token binding that is equal to or less than the version of the TLS binding protocol that the client device 108 indicated that the client device 108 could support in the ClientHelloMessage. The ServerHelloMessage can also include a masterkey nonce value, which can be a randomly generated number value, that can later be used to generate a master key that can be used to encrypt communications that are part of the TLS session. The ServerHelloMessage can include an indicator in which the content server 120 can acknowledge whether the content server 120 accepts the suppression of sending of attestation information by the client device 108 when future sessions between the client device 108 and the content server 120 are established.

The masterkey nonce value can also be used to determine whether the client device 108 is possession of the private key associated with the access token. The content server 120 can also be configured to use the public key included in the access token provided in the ClientHelloMessage to encrypt the masterkey nonce value included in the ClientHelloMessage using a public key associated with the client device 108. The content server 120 can be configured to send the encrypted masterkey nonce value to the client device 108 in the ServerHelloMessage or in another message send by the content server 120 to the client device 108. The client device 108, upon receiving the masterkey encrypted nonce value, can decrypt the encrypted masterkey nonce value using the appropriate private key maintained by the client device 108. The client device 108 can then return the encrypted masterkey nonce value to the content server 120. The client device 108 may reencrypt the masterkey nonce value with a public key of the content server 120 before sending the masterkey nonce value back to the content server 120. If the client device 108 does not provide the correct unencrypted masterkey nonce value (or the masterkey nonce value encrypted with the public key of the content server 120) to the content server 120, the content server 120 can be configured to terminate the secure communication session with the client device 108. The client device 108 can be configured to send the nonce value back to the content server 120 in a message following the ServerHelloMessage at stage 920. In some implementations, the client device 108 can be configured to send the masterkey nonce value back to the server with the message sent in one of stages 926, 930, or 940 or in another message not illustrated in the signal flow diagram. The process of encryption of the masterkey nonce value by the content server 120, the decryption by the client device 108, and the sending of the decrypted nonce value back to the content server 120 can be used by the content server 120 to establish that the client device 108 possesses the private key associated with the binding of the access token to the secure communication session. The masterkey nonce value is only used during the negotiation phase between the client device 108 and the content server 120 to establish a shared MasterSecret which is discussed in greater detail below. The masterkey nonce value is distinct from a nonce value that may be sent to the client device 108 by the content server 120 to determine whether the client device 108 is in possession of an authentication token by digitally signing the nonce value using the private key of the private key—public key pair associated with the authentication token.

In other embodiments, the content server 120 can be configured to extract information from the access token that has been encrypted using the public key associated with the client device 108. The access token may not include the public key itself in such implementations, and the content server 120 can be configured to obtain the public key from the client device 108 by sending the ClientCertificateRequest message discussed below to the client device 108, and the client device 108 can respond with a ClientCertificate message that includes the public key of the client device 108. The content server 120 can send a message to the client device 108 requesting that the client device 108 decrypt the information from the access token that has been encrypted using the public associated with the client device 108. The client device 108 decrypts the encrypted information using the private key of the client device 108 and can include the decrypted value in response message to the content server 120. The client device 108 can be configured to encrypt the response message contents using a public key of the content server 120 to ensure that the information extracted from the token is not transmitted in an unencrypted form across the network 112. The content server 120 can be configured compare the response from the client device 108 with a reference value associated with the client device to determine whether the client device 108 is in possession of the private key of the private key-public key pair used to generate the access token. The reference value may be obtained from the access server 110 or may be maintained in a database of the content server 120 where the content server 120 implements the functionality of the access server 110.

Once the possession of the private key and the access token by the client device 108 have been established, the content server can be configured to examine the attestation information. The content server can be configured to access policy information and use the policy information and the attestation information to determine whether the establish the TLS connection with the client device 108. The policy information can include specific requirements that are imposed on specific applications, content, and/or services provided by the content server 120. The content server 120 can also compare the attestation information provided by the client device 108 with policy information to determine whether to establish the secure communication session with the client device. The content server 120 can use the attestation information to determine the configuration of the client device 108 and can use the attestation information to determine how the client device 108 is managing the private keys and the access tokens used by the content server 120. As discussed above, the content server 120 can use policy information to determine whether the client device 108 is managing the access tokens and/or the private keys in a sufficiently secure manner, and the content server 120 can refuse to terminate the secure communication session and/or a connection associated with the secure communication session responsive to the client device 108 not satisfying the security requirements associated with management of the access token and/or the encryption keys imposed by the policy.

The content server 120 can send a ServerCertificate message to the client device 108 (stage 922). The ServerCertificate message can include the server's public key. The client device 108 can be configured to use the public key to authenticate the content server 120 and to encrypt the PreMasterSecret (discussed below).

The content server 120 can also send a ClientCertificateRequest message to the client device 108 (stage 924) requesting that the client device 108 provide the client device's public key. Stage 924 can be optional. The client device 108 can provide the public key with the attestation information and the access token provided with the ClientHelloMessage in stage 910. The content server 120 can use the public key of the client device 108 to authenticate the client device 108. In some embodiments, the public key of the client device 108 can be included in the access token, and the content server 120 can be configured to compare the public key provided by the client device 108 with public key information extracted from the access token to determine whether there is a mismatch between the public key provided by the client device 108 and the public key information extracted from the access token.

The client device 108 can respond to the ServerHelloMessage with a ClientKeyExchange message (stage 930). The client device 108 can be configured to generate a second masterkey nonce value, which can be a randomly generated number value. The client device 108 can then encrypt the second masterkey nonce value with the public key of the certificate of the content server 120. The client device 108 can obtain the certificate from the content server 120 via the ServerHelloMessage or via another message from the content server 120. The client device 108 can use the cipher suite indicated in the ServerHelloMessage to encrypt the second masterkey nonce value using the public key of the content server 120. The encrypted second nonce value can be sent to the server with the ClientKeyExchange message. The encrypted data can also be referred to as a “PreMasterSecret” value. The client device 108 and the content server 120 can be configured to use the PreMasterSecret to compute a MasterSecret value. The MasterSecret value can be used to generate other key data. The client device 108 and the content server 120 can be configured to pass the MasterSecret value through one or more Pseudo-Random Number Generators (PRNGs) to generate key data to be used during the TLS session. The second masterkey nonce value is only used during the negotiation phase between the client device 108 and the content server 120 to establish a shared MasterSecret, which can be used generate other key data. Like the first masterkey nonce value discussed above, the second masterkey nonce value is also distinct from a nonce value that may be sent to the client device 108 by the content server 120 to determine whether the client device 108 is in possession of an authentication token by digitally signing the nonce value using the private key of the private key—public key pair associated with the authentication token.

The client device 108 can follow the ClientKeyExchange message with a ChangeCipherSpec message (stage 940). The ChangeCipherSpec can be used to signal to the content server 120 that subsequent communications from client device 108 that are part of the TLS session will be encrypted using the session keys. The client device 108 can follow the ChangeCipherSpec message with a Finished message (stage 950). The Finished message can comprise contents encrypted using the key data generated during the negotiation phase with the content server 120.

The content server 120 can generate a ChangeCipherSpec message to the client device 108 responsive to receiving the Finished message from the client device 108 (stage 960). The content server 120 can be configured to decrypt the Finished message from the client device 108 using the exchanged secret information. If the content server 120 cannot successfully decrypt the contents of the finished message, the TLS connection session can be halted and the connection between the client device 108 and the content server 120 can be torn down. Otherwise, if the content server 120 successfully decrypts the contents of the Finished message from the client device 108, the content server 120 can send the ChangeCipherSpec message to the client device 108. The content server 120 can follow the ChangeCipherSpec message with a Finished message (stage 970). The contents of the Finished message are encrypted by the content server 120 using the selected cipher suite. The client device 108 can decrypt the Finished message upon receipt, and if the client device 108 cannot decrypt the contents of the Finished message from the content server 120, the TLS connection session can be halted and the connection between the client device 108 and the content server 120 can be torn down. Otherwise, if the client device 108 can successfully decrypt the contents of the Finished message from the server, the TLS handshake is completed, and the client device 108 and the content server 120 can communicate data over the TLS connection that has been encrypted using the keys generated during the handshake process and using the cipher suite selected during the handshake process.

Example implementations according to the disclosure include:

E1. An example method for managing data communications, the method comprising:

receiving a request to establish a secure communication session between a client device and a server from the client device, the secure communication session comprising one or more communication subsessions in which data is exchanged between the client device and the server, wherein receiving the request to establish the secure communication session comprises
receiving an access token and attestation information from the client device, the access token comprising information for securely binding the one or more communication subsessions to the secure communication session, and the attestation information attesting to security of management of the access token by the client device;

determining the secure communication with the client device can be established based on the access token and the attestation information; and

establishing the secure communication session responsive a determination that the secure communication session can be established.

E2. The method of example E1, wherein determining the secure communication with the client device can be established based on the access token and the attestation information further comprises:

determining whether the attestation information provided by the client device satisfies one or more policy requirements associated with an application associated with a respective one of the one or more communication subsessions; and

terminating the respective one of the one or more communication subsessions responsive to the attestation information not satisfying the one or more policy requirements associated with the application.

E3. The method of example E2, wherein determining whether the attestation information provided by the client device satisfies the one or more policy requirements associated with the application associated with a respective one of the one or more communication subsessions further comprises:

determining whether the attestation information indicates that a private key associated with the client device is stored in a secure component of the client device.

E4. The method of example E2, wherein determining the secure communication with the client device can be established based on the access token and the attestation information further comprises:

determining whether the attestation information has been signed by a private key associated with a secure component of the client device.

E5. The method of example E1, wherein determining the secure communication with the client device can be established based on the access token and the attestation information:

accessing information about the client device; and

comparing the attestation information with the information about the client device to determine whether the attestation information matches the information about the client device.

E6. An apparatus for managing data communications, the apparatus comprising:

means for receiving a request to establish a secure communication session between a client device and a server from the client device, the secure communication session comprising one or more communication subsessions in which data is exchanged between the client device and the server, wherein the means for receiving the request to establish the secure communication session comprises
means for receiving an access token and attestation information from the client device, the access token comprising information for securely binding the one or more communication subsessions to the secure communication session, and the attestation information attesting to security of management of the access token by the client device;

means for determining the secure communication with the client device can be established based on the access token and the attestation information; and

means for establishing the secure communication session responsive a determination that the secure communication session can be established.

E7. The apparatus of example E6, wherein the means for determining the secure communication with the client device can be established based on the access token and the attestation information further comprises:

means for determining whether the attestation information provided by the client device satisfies one or more policy requirements associated with an application associated with a respective one of the one or more communication subsessions; and

means for terminating the respective one of the one or more communication subsessions responsive to the attestation information not satisfying the one or more policy requirements associated with the application.

E8. The apparatus of example E7, wherein the means for determining whether the attestation information provided by the client device satisfies the one or more policy requirements associated with the application associated with a respective one of the one or more communication subsessions further comprises:

means for determining whether the attestation information indicates that a private key associated with the client device is stored in a secure component of the client device.

E9. The apparatus of example E7, wherein the means for determining the secure communication with the client device can be established based on the access token and the attestation information further comprises:

means for determining whether the attestation information has been signed by a private key associated with a secure component of the client device.

E10. The apparatus of example E6, wherein the means for determining the secure communication with the client device can be established based on the access token and the attestation information:

means for accessing information about the client device; and

means for comparing the attestation information with the information about the client device to determine whether the attestation information matches the information about the client device.

E11. A non-transitory, computer-readable medium, having stored thereon computer-readable instructions for managing data communications, comprising instructions configured to cause at least one processor to:

receive a request to establish a secure communication session between a client device and a server from the client device, the secure communication session comprising one or more communication subsessions in which data is exchanged between the client device and the server, wherein the instructions configured to cause the at least one processor to receive the request to establish the secure communication session comprise instructions configured to cause the at least one processor to
receive an access token and attestation information from the client device, the access token comprising information for securely binding the one or more communication subsessions to the secure communication session, and the attestation information attesting to security of management of the access token by the client device;

determine the secure communication with the client device can be established based on the access token and the attestation information; and

establish the secure communication session responsive a determination that the secure communication session can be established.

E12. The non-transitory, computer-readable medium of example E11, wherein the instructions configured to cause the at least one processor to determine the secure communication with the client device can be established based on the access token and the attestation information further comprise instructions configured to cause the at least one processor to:

determine whether the attestation information provided by the client device satisfies one or more policy requirements associated with an application associated with a respective one of the one or more communication subsessions; and

terminate the respective one of the one or more communication subsessions responsive to the attestation information not satisfying the one or more policy requirements associated with the application.

E13. The non-transitory, computer-readable medium of example E12, wherein the instructions configured to cause the at least one processor to determine whether the attestation information provided by the client device satisfies the one or more policy requirements associated with the application associated with a respective one of the one or more communication subsessions further comprise instructions configured to cause the at least one processor to:

determine whether the attestation information indicates that a private key associated with the client device is stored in a secure component of the client device.

E14. The non-transitory, computer-readable medium of example E12, wherein the instructions configured to cause the at least one processor to determine the secure communication with the client device can be established based on the access token and the attestation information further comprise instructions configured to cause the at least one processor to:

determine whether the attestation information has been signed by a private key associated with a secure component of the client device.

E15. The non-transitory, computer-readable medium of example E11, wherein the instructions configured to cause the at least one processor to determine the secure communication with the client device can be established based on the access token and the attestation information further comprise instructions configured to cause the at least one processor to:

access information about the client device and comparing the attestation information with the information about the client device to determine whether the attestation information matches the information about the client device.

E16. A computing device comprising:

a processor configured to:
receive a request to establish a secure communication session between a client device and a server from the client device, the secure communication session comprising one or more communication subsessions in which data is exchanged between the client device and the server, wherein the instructions configured to cause the processor to receive the request to establish the secure communication session comprise instructions configured to cause the processor to
   receive an access token and attestation information from the client device, the access token comprising information for securely binding the one or more communication subsessions to the secure communication session, and the attestation information attesting to security of management of the access token by the client device;
determine the secure communication with the client device can be established based on the access token and the attestation information; and
establish the secure communication session responsive a determination that the secure communication session can be established.
   E17. The computing device of example E16, wherein the processor is further configured to:

determine whether the attestation information provided by the client device satisfies one or more policy requirements associated with an application associated with a respective one of the one or more communication subsessions; and

terminate the respective one of the one or more communication subsessions responsive to the attestation information not satisfying the one or more policy requirements associated with the application.

E18. The computing device of example E17, wherein the processor is further configured to:

determine whether the attestation information indicates that a private key associated with the client device is stored in a secure component of the client device.

E19. The computing device of example E17, wherein the processor is further configured to:

determine whether the attestation information has been signed by a private key associated with a secure component of the client device.

E20. The computing device of example E16, wherein the processor is further configured to: access information about the client device and comparing the attestation information with the information about the client device to determine whether the attestation information matches the information about the client device.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Memory may be implemented within the computing-based device 410 or external to the device. As used herein the term “memory” refers to any type of long term, short term, volatile, nonvolatile, or other memory and is not to be limited to any particular type of memory or number of memories, or type of media upon which memory is stored.

If implemented in-part by hardware or firmware along with software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

As used herein, a mobile device or station (MS) refers to a device such as a cellular or other wireless communication device, a smartphone, tablet, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” (or “mobile device” or “wireless device”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, tablet devices, etc., which are capable of communication with a server, such as via the Internet, WiFi, or other network, and to communicate with one or more types of nodes, regardless of whether satellite signal reception, assistance data reception, and/or position-related processing occurs at the device, at a server, or at another device or node associated with the network. Any operable combination of the above are also considered a “mobile station.” A mobile device may also be referred to as a mobile terminal, a terminal, a user equipment (UE), a device, a Secure User Plane Location Enabled Terminal (SET), a target device, a target, or by some other name.

While some of the techniques, processes, and/or implementations presented herein may comply with all or part of one or more standards, such techniques, processes, and/or implementations may not, in some embodiments, comply with part or all of such one or more standards.

What is claimed:

1. A method for managing data communications, the method comprising:
establishing a secure communication session between a client device and a server over a network, the secure communication session comprising one or more communication subsessions in which data is exchanged between the client device and the server, wherein establishing the secure communication session comprises:
providing an access token to the server, the access token comprising information for securely binding the one or more communication subsessions to the secure communication session, and
providing attestation information to the server, the attestation information attesting to security of management of the access token by the client device.

2. The method of claim 1, wherein providing the attestation information to the server comprises signing at least a portion of the attestation information with an attestation private key associated with a secure component of the client device and providing the attestation information that has been signed to the server.

3. The method of claim 2, further comprising:
estimating a lifespan of a communication subsession associated with the secure communication session; and
selecting a technique for signing the access token from a plurality of techniques of which the client device is configured to perform based on the lifespan estimated of the communication sub session and an estimate of a time to perform the technique selected for signing at least the portion of the attestation information.

4. The method of claim 1, further comprising:
selecting a technique for signing data to be communicated to the server from a plurality of techniques of which the client device is configured to perform based on policy information received from the server.

5. The method of claim 1, wherein the attestation information comprises at least one of information identifying which encryption algorithms that the client device is configured to support, information indicating whether the access token is stored in a secured memory location, or information indicating whether a private key associated with the client device is stored in the secured memory location.

6. The method of claim 1, wherein providing the attestation information to the server further comprises:
providing an indicator that the client device will suppress sending the attestation information for future secure communication sessions between the client device and the server.

7. An apparatus for managing data communications, the apparatus comprising:
means for establishing a secure communication session between the apparatus and a server over a network, the secure communication session comprising one or more communication subsessions in which data is exchanged between the apparatus and the server, wherein the means for establishing the secure communication session comprises:
means for providing an access token to the server, the access token comprising information for securely binding the one or more communication subsessions to the secure communication session, and
means for providing attestation information to the server, the attestation information attesting to security of management of the access token by the apparatus.

8. The apparatus of claim 7, wherein the means for providing the attestation information to the server comprises means for signing at least a portion of the attestation information with an attestation private key associated with a secure component of the apparatus and providing the attestation information that has been signed to the server.

9. The apparatus of claim 8, further comprising:
means for estimating a lifespan of a communication subsession associated with the secure communication session; and
means for selecting a technique for signing the access token from a plurality of techniques of which the apparatus is configured to perform based on the lifespan estimated of the communication subsession and an estimate of a time to perform the technique selected for signing at least the portion of the attestation information.

10. The apparatus of claim 7, further comprising:
means for selecting a technique for signing data to be communicated to the server from a plurality of techniques of which the apparatus is configured to perform based on policy information received from the server.

11. The apparatus of claim 7, wherein the attestation information comprises at least one of information identifying which encryption algorithms that the apparatus is configured to support, information indicating whether the access token is stored in a secured memory location, or information indicating whether a private key associated with the apparatus is stored in the secured memory location.

12. The apparatus of claim 7, wherein the means for providing the attestation information to the server further comprises:
means for providing an indicator that the apparatus will suppress sending the attestation information for future secure communication sessions between the apparatus and the server.

13. A non-transitory, computer-readable medium, having stored thereon computer-readable instructions for managing data communications, comprising instructions configured to cause at least one processor to:
establish a secure communication session between a client device and a server over a network, the secure communication session comprising one or more communication subsessions in which data is exchanged between the client device and the server, wherein the instructions configured to cause the at least one processor to establish the secure communication session comprises instructions to cause the at least one processor to:
provide an access token to the server, the access token comprising information for securely binding the one or more communication subsessions to the secure communication session, and
provide attestation information to the server, the attestation information attesting to security of management of the access token by the client device.

14. The non-transitory, computer-readable medium of claim 13, wherein the instructions configured to cause the at least one processor to provide the attestation information to the server comprise instructions configured to cause the at least one processor to sign at least a portion of the attestation information with an attestation private key associated with a secure component of the client device and providing the attestation information that has been signed to the server.

15. The non-transitory, computer-readable medium of claim 14, further comprising instructions configured to cause the at least one processor to:
estimate a lifespan of a communication subsession associated with the secure communication session; and
select a technique for signing the access token from a plurality of techniques of which the client device is configured to perform based on the lifespan estimated of the communication sub session and an estimate of a time to perform the technique selected for signing at least the portion of the attestation information.

16. The non-transitory, computer-readable medium of claim 13, further comprising instructions configured to cause the at least one processor to:
select a technique for signing data to be communicated to the server from a plurality of techniques of which the client device is configured to perform based on policy information received from the server.

17. The non-transitory, computer-readable medium of claim 13, wherein the attestation information comprises at least one of information identifying which encryption algorithms that the client device is configured to support, information indicating whether the access token is stored in a secured memory location, or information indicating whether a private key associated with the client device is stored in the secured memory location.

18. The non-transitory, computer-readable medium of claim 13, further comprising instructions configured to cause the at least one processor to:
provide an indicator that the client device will suppress sending the attestation information for future secure communication sessions between the client device and the server.

19. A client device comprising:
a processor configured to:
establish a secure communication session between the client device and a server over a network, the secure communication session comprising one or more communication subsessions in which data is exchanged between the client device and the server, wherein the processor is configured to:
provide an access token to the server, the access token comprising information for securely binding the one or more communication subsessions to the secure communication session, and
provide attestation information to the server, the attestation information attesting to security of management of the access token by the client device.

20. The client device of claim 19, wherein the processor is configured to sign at least a portion of the attestation information with an attestation private key associated with a secure component of the client device and providing the attestation information that has been signed to the server.

21. The client device of claim 20, wherein the processor is further configured to:
estimate a lifespan of a communication subsession associated with the secure communication session; and
select a technique for signing the access token from a plurality of techniques of which the client device is configured to perform based on the lifespan estimated of the communication sub session and an estimate of a time to perform the technique selected for signing at least the portion of the attestation information.

22. The client device of claim 19, wherein the processor is further configured to:
select a technique for signing data to be communicated to the server from a plurality of techniques of which the client device is configured to perform based on policy information received from the server.

23. The client device of claim 19, wherein the attestation information comprises at least one of information identifying which encryption algorithms that the client device is configured to support, information indicating whether the access token is stored in a secured memory location, or information indicating whether a private key associated with the client device is stored in the secured memory location.

24. The client device of claim 19, wherein the processor is further configured to:
provide to the server an indicator that the client device will suppress sending the attestation information for future secure communication sessions between the client device and the server.
